(19) United States
(12) Patent Application Publication
(10) Pub. No.: US 2026/0285442 A1
(43) Pub. Date: Sep. 24, 2026

(54) MICROMOBILITY DEVICE BRAKE SYSTEMS AND METHODS

(71) Applicant: Also, Inc., Palo Alto, CA (US)

(72) Inventors: Adam Christopher BENDER, San Francisco, CA (US); Nikola POPOV, Los Gatos, CA (US); Mark Oliver Dixon KAUFMAN, San Jose, CA (US); Jiazhou ZHONG, Sunnyvale, CA (US); Jennifer UANG, San Francisco, CA (US)

(73) Assignee: Also, Inc., Palo Alto, CA (US)

(21) Appl. No.: 19/566,412

(22) Filed: Mar. 13, 2026

Related U.S. Application Data
(60) Provisional application No. 63/774,203, filed on Mar. 19, 2025.

(51) Int. Cl. B62M 6/55; B62M 6/45; B62M 6/90; B60L 7/10

(52) U.S. Cl. CPC B62M 6/55; B62M 6/45; B62M 6/90; B60L 7/10; B60L 2200/12

(57) ABSTRACT

A brake system of a micromobility device can include a drive unit. The drive unit can include a traction motor coupled with a wheel of the micromobility device. The traction motor can convert electrical power to mechanical power to drive the wheel, thereby propelling the micromobility device. The traction motor can exert, based on a brake input, resistive torque on the wheel, thereby converting mechanical power from the wheel to electrical power and causing the micromobility device to slow without use of friction brakes. The micromobility device can include a resistor that can receive electrical power from the traction motor and can convert the electrical power to heat. The micromobility device can include a control device that can direct the electrical power generated by the traction motor to the resistor based on the battery having a state of charge greater than or equal to a threshold.

### CROSS-REFERENCE TO RELATED APPLICATION

This U.S. Patent Application claims the benefit and priority to U.S. Provisional Application No. 63/774,203, filed Mar. 19, 2025, the entire disclosures of which is hereby incorporated by reference herein.

### BACKGROUND

Vehicles can include passengers and be used to convey the passengers from one location to another.

### SUMMARY OF THE INVENTION

At least one aspect is directed to a micromobility device. The micromobility device can include a frame. The micromobility device can include a first wheel and a second wheel rotatably coupled with the frame. The micromobility device can include a battery coupled with the frame. The micromobility device can include a drive unit coupled with the frame. The drive unit can include a pedal assembly that can receive mechanical input from a user. The drive unit can include a generator coupled with the pedal assembly and that can generate electrical power to charge the battery based on the mechanical input applied by the user to the pedal assembly. The drive unit can include a traction motor coupled with the second wheel. The traction motor can convert electrical power to mechanical power to drive the second wheel, thereby propelling the micromobility device. The traction motor can exert, based on a brake input, resistive torque on the second wheel, thereby converting mechanical power from the second wheel to electrical power and causing the micromobility device to slow without use of friction brakes. The micromobility device can include at least one resistor that can receive electrical power from the traction motor and can convert the electrical power to heat. The micromobility device can include a control device. The control device can direct the electrical power generated by the traction motor to the battery based on the battery having a state of charge less than a threshold. The control device can direct the electrical power generated by the traction motor to the at least one resistor based on the battery having a state of charge greater than or equal to a threshold.

At least one aspect is directed to a brake system of a micromobility device. The brake system can include a drive unit coupled with a frame of a micromobility device. The drive unit can include a pedal assembly that can receive mechanical input from a user of the micromobility device. The drive unit can include a generator coupled with the pedal assembly. The generator can generate electrical power to charge the battery based on the mechanical input applied by the user to the pedal assembly. The drive unit can include a traction motor coupled with a wheel of the micromobility device. The traction motor can convert electrical power to mechanical power to drive the wheel, thereby propelling the micromobility device. The traction motor can exert, based on a brake input, resistive torque on the wheel, thereby converting mechanical power from the wheel to electrical power and causing the micromobility device to slow without use of friction brakes. The micromobility device can include at least one resistor that can receive electrical power from the traction motor and can convert the electrical power to heat. The micromobility device can include a control device. The control device can direct the electrical power generated by the traction motor to the battery based on the battery having a state of charge less than a threshold. The control device can direct the electrical power generated by the traction motor to the at least one resistor based on the battery having a state of charge greater than or equal to a threshold.

At least one aspect is directed to a method. The method can include providing a frame of a micromobility device. The method can include rotatably coupling a first wheel and a second wheel with the frame. The method can include coupling a drive unit with the frame. The drive unit can include a battery, a pedal assembly that can receive mechanical input from a user, a generator, and a traction motor. The method can include coupling the generator with the pedal assembly. the generator can generate electrical power to charge the battery based on the mechanical input applied by the user to the pedal assembly. The method can include coupling the traction motor with the second wheel. The traction motor convert electrical power to mechanical power to drive the second wheel, thereby propelling the micromobility device. The traction motor can exert, based on a brake input, resistive torque on the second wheel, thereby converting mechanical power from the second wheel to electrical power and causing the micromobility device to slow without use of friction brakes. The method can include providing at least one resistor that can receive electrical power from the traction motor and to convert the electrical power to heat. The method can include directing, by a control device, the electrical power generated by the traction motor to the battery based on the battery having a state of charge less than a threshold. The method can include directing, by a control device, the electrical power generated by the traction motor to the at least one resistor based on the battery having a state of charge greater than or equal to a threshold.

At least one aspect is directed to a method. The method can include providing a micromobility device. The micromobility device can include a frame. The micromobility device can include a first wheel and a second wheel rotatably coupled with the frame. The micromobility device can include a battery coupled with the frame. The micromobility device can include a drive unit coupled with the frame. The drive unit can include a pedal assembly that can receive mechanical input from a user. The drive unit can include a generator coupled with the pedal assembly and that can generate electrical power to charge the battery based on the mechanical input applied by the user to the pedal assembly. The drive unit can include a traction motor coupled with the second wheel. The traction motor can convert electrical power to mechanical power to drive the second wheel, thereby propelling the micromobility device. The traction motor can exert, based on a brake input, resistive torque on the second wheel, thereby converting mechanical power from the second wheel to electrical power and causing the micromobility device to slow without use of friction brakes. The micromobility device can include at least one resistor that can receive electrical power from the traction motor and to convert the electrical power to heat. The micromobility device can include a control device. The control device can direct the electrical power generated by the traction motor to the battery based on the battery having a state of charge less than a threshold. The control device can direct the electrical power generated by the traction motor to the at least one resistor based on the battery having a state of charge greater than or equal to a threshold.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a perspective view of an example micromobility device, in accordance with some aspects.

FIG. 2 depicts a block diagram of an example drive unit of a micromobility device, in accordance with some aspects.

FIG. 3 depicts a cross-sectional view of an example drive unit and down tube, in accordance with some aspects.

FIG. 4 depicts a cross-sectional view of an example drive unit, in accordance with some aspects.

FIG. 5 depicts a perspective view of a resistor within a drive unit, in accordance with some aspects.

FIG. 6 depicts a perspective view of a resistor within a down tube, in accordance with some aspects.

FIG. 7 depicts a cross sectional view of a down tube and a resistor therein, in accordance with some aspects.

FIG. 8 depicts a cross sectional view of a resistor, in accordance with some aspects.

FIG. 9 is a perspective view of a drive unit, in accordance with some aspects.

FIG. 10 is a schematic diagram of a brake system, in accordance with some aspects.

FIG. 11 is a flow diagram of a method of assembling a bike, in accordance with some aspects.

FIG. 12 is a flow diagram of a method of providing a bike, in accordance with some aspects.

### DETAILED DESCRIPTION

Following below are more detailed descriptions of various concepts related to, and implementations of, methods, apparatuses, and systems of a brake system of a micromobility device, such as a bike. The various concepts introduced above and discussed in greater detail below may be implemented in any of numerous ways.

This technical solution is generally directed to a brake system for a micromobility device, such as an electric bike (“e-bike”). The brake system allows the bike to use the electrical systems of the bike to reduce the speed of the bike and recover energy generated therefrom. For example, the bike can include at least one motor/generator that can facilitate a reduction of speed of the bike when a throttle is released or a brake is actuated. The motor can convert kinetic energy of the bike into electrical energy. The electrical energy can be stored within a battery or capacitor of the e-bike or distributed elsewhere if the battery or capacitor is at capacity.

The disclosed solutions can have the technical advantage of enabling a regenerative braking system of a micromobility device (such as an e-bike) even when the micromobility device’s onboard energy storage devices (e.g., batteries, capacitors) are at capacity. In some examples, the motor of the bike can convert and divert enough of the bike’s kinetic energy such that the bike does not need additional friction brakes. For example, the brake system of the bike can include at least one battery. The battery can receive at least some of the generated electrical energy if the battery is below a maximum charge threshold (e.g., the battery is not fully charged). The brake system can include at least one resistor. The resistor can receive at least some of the generated electrical energy (e.g., once the battery is fully charged). The brake system can include at least one heat sink. The heat sink can receive heat from the resistor. Accordingly, the kinetic energy of the bike can be converted into electrical energy and heat, which can be distributed throughout the brake system to control which components receive how much energy and maintain a desired system temperature.

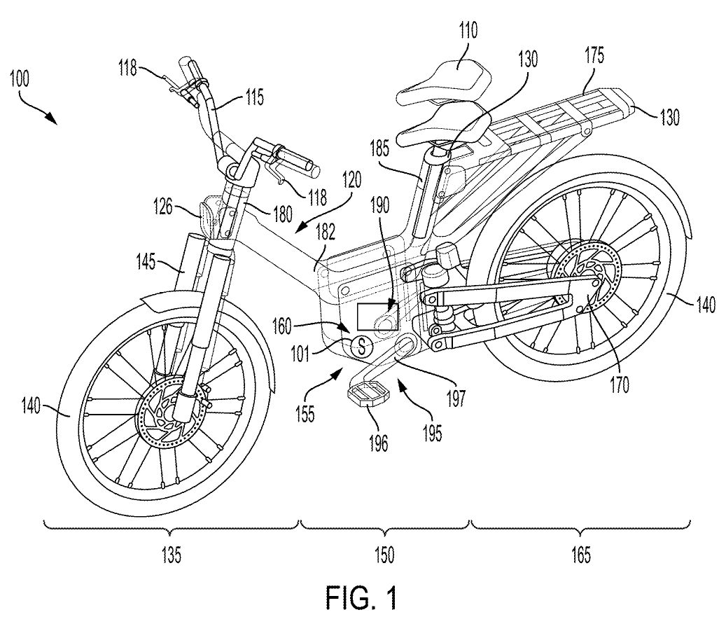

FIG. 1 depicts an example perspective view of a micromobility device 100, shown as a bicycle 100. The bike 100 can be an electric bike 100 installed with at least one battery pack 215. The bike 100 can be a human-operated bike 100. The bike 100 can be or include a micromobility device such as single rider bicycles, tandem bicycles, cargo bicycles, motor-assist bicycles, pedicabs, electric-assist bicycles, road bicycles, mountain bicycles, unicycles, segways, or scooters, among others. In other examples, the bike 100 can include four wheels, with a driver position between left/right side wheels. The battery pack 215 can also be used as an energy storage system to power a building, such as a residential home or commercial building. The bike 100 can be fully electric or partially electric (e.g., pedal-powered) and further, the bike 100 can be fully autonomous, partially autonomous, semi-autonomous, or unmanned. The bike 100 can also be human operated or non-autonomous. A human operator or the rider of the bike 100 can sit on a saddle 110 to operate the bike 100. The rider of the bike 100 can steer, grip, balance, or otherwise control the bike 100 using the handlebar 115. While referred to herein as bike 100, the bike 100 can include any micromobility device.

The bike 100 can include a frame 120. The frame 120 can support various components of the bike 100, such as a handlebar 115, the saddle 110, the battery 215, at least one front light assembly 126, and at least one rear light assembly 130. The handlebar 115 or some other portion of the frame 120 can include brake controllers 118 configured to receive user inputs. For example, the brake controller 118 can control a brake system 125 of the bike 100. A rider can actuate (e.g., squeeze) a lever of the brake controller 118 to cause the bike 100 to brake and slow down. The frame 120 can span a front portion 135. The front portion 135 can support, be coupled with, or include, for example, a wheel 140 of the bike 100, a fork 145 of the bike 100, a head tube 180 of the bike 100, the handlebar 115, or the front light assembly 126, among other components. The bike 100 can include two or more wheels 140 (e.g., a front wheel 140 and a rear wheel 140). The wheels 140 can be rotatably coupled with the frame 120. The frame 120 can span a middle portion 150 (e.g., a central portion). The middle portion 150 can support, be coupled with, or include, for example, the saddle 110, the battery 215, a drive unit 155 of the bike 100, a down tube 182 extending between the drive unit 155 and the head tube 180, a crank assembly 160 of the bike 100, or a top tube 185, among other components.

The frame 120 can include the middle portion 150 including the rear light assembly 130. The frame 120 can include a rear portion 165. The rear portion 165 can support, be coupled with, or include, for example, a rear wheel 140 of the bike 100, the rear light assembly 130, a drivetrain 172 of the bike 100, or a rear member 175 of the bike 100, among other components. The drivetrain 172 of the bike 100 can be a chain, gear, belt, or some combination thereof that couples the drive unit 155 with the rear wheel 140 of the bike 100 such that the drive unit 155 can rotate or drive the rear wheel 140. The rear member 175 of the bike 100 can be a rear fender, a rack configured to stow or support luggage or some other object, a child seat, a pet carrier, a basket, or some other object. The battery 215 can be disposed anywhere within the frame 120.

The bike 100 can include at least one battery 215 or battery pack 215 that can include at least one battery module or at least one battery cell. The battery 215 can be electrically coupled with the bike 100 (e.g., to the drive unit 155, to the front light assembly 126, the rear light assembly 130, or some other component(s)). For example, the battery 215 can provide electrical energy to the bike 100 to power the bike 100. For example, the battery 215 can provide electrical energy to the drive unit 155 to cause the drive unit 155 to operate (e.g., to rotate the wheel 140 of the bike 100). The battery 215 can be installed or placed within the bike 100. For example, the battery 215 can be installed on the frame 120 of the bike 100 within one or more of the front portion 135, the middle portion 150, or the rear portion 165. The battery 215 can be integrally coupled with the frame 120 such that it is not removable. The battery 215 can be detachably coupled with the frame 120 such that in can be removed (e.g., to charge the battery 215). The battery 215 can include or connect with at least one busbar, e.g., a current collector element. For example, the busbar can include electrically conductive material to connect or otherwise electrically couple the battery 215 with other electrical components of the bike 100 to provide electrical power to various systems or components of the bike 100, such as the front light assembly 126, the rear light assembly 130, or some other system.

The bike 100 can include at least one sensor 101. The number, placement, and type of sensors 101 included in the vehicle 100 are shown for example purposes only. That is, in other configurations, the number, placement, and type of sensors 101 may differ. The sensors 101 can be real or virtual (i.e., a non-physical sensor that is structured as program logic in the control device 190 that makes various estimations or determinations). The sensors 101 can serve various functions. For example, a sensor 101 can be structured as a temperature sensor configured to collect data indicative of a temperature of a component of the bike 100. The bike 100 can include sensors structured as speed sensors, inertial measurement units, or load sensors, among other types of sensors.

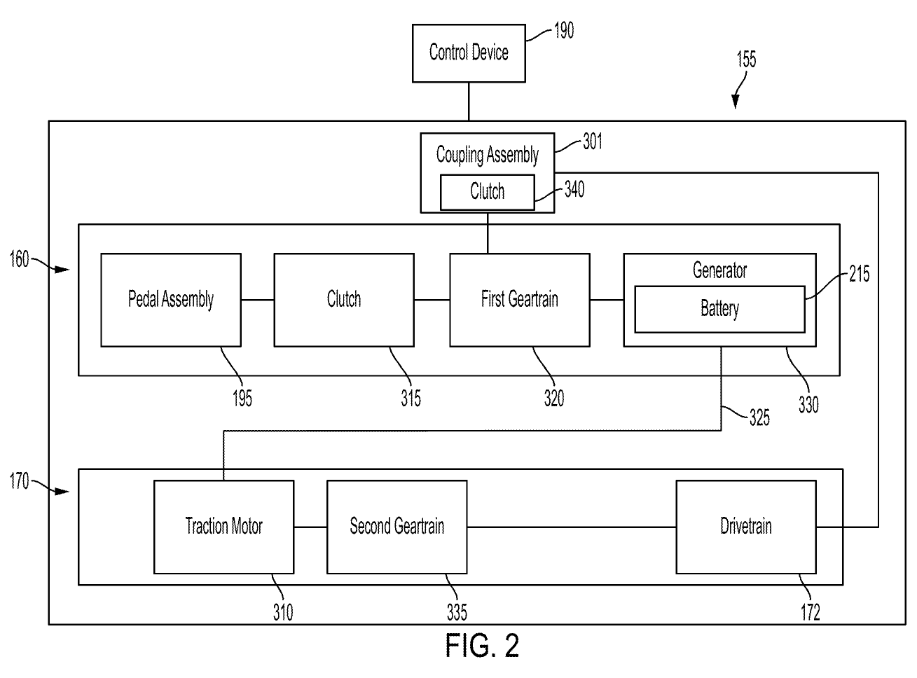

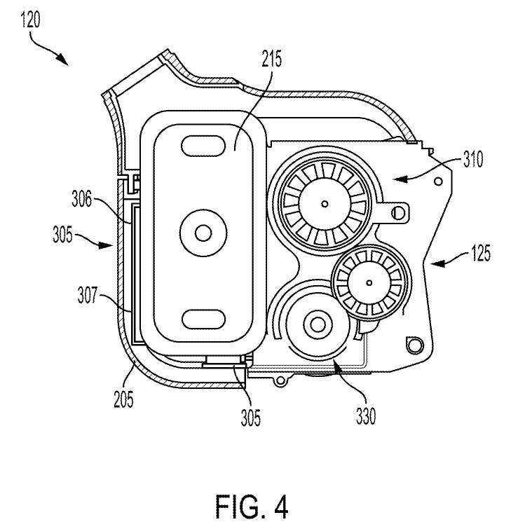

As depicted in FIGS. 1–4, among others, the bike 100 can include at least one drive unit 155. FIG. 2 depicts a schematic diagram of an example drive unit 155. The drive unit 155 can include at least one crank assembly 160 and at least one traction assembly 170. The crank assembly 160 can receive a mechanical force from a user (e.g., a mechanical force against a pedal). The traction assembly can include the wheel 140 and can include a geartrain or a motor to cause the wheel to rotate, as is discussed in detail below. The drive unit 155 can be a hybrid propulsion system for a bicycle 100 that can be powered by manual power (e.g., a mechanical force applied by a user to a pedal of the bike 100, battery power (e.g., power provided by the battery 215), or a combination thereof. For example, the drive unit 155 can allow the user to pedal the bike 100 to propel the bike 100, to use power provided by the battery 215 to propel the bike 100, or use a combination of the user’s manual force against the pedal and the power provided by the battery 215 to propel the bike 100.

The drive unit 155 can be a series or parallel system, and can be configured to modulate between both. For example, the drive unit 155 can be or include a drive unit 155 that can switch between two configurations: a series configuration and a parallel configuration. The series configuration provides a single path for power to travel to drive the bike 100. The series configuration can include an electrical connection between the crank assembly 160 and a traction assembly 170 of the bike 100. Mechanical power from the crank assembly 160 can be converted to electrical power via a generator 330 of the drive unit 155. The electrical power can be transferred to a traction motor 310 of the traction assembly 170 via an electrical bus 325. The traction motor 310 can convert the electrical energy back to mechanical energy to drive the bicycle 100. To switch to the parallel system, the drive unit 155 can include an actuatable coupling assembly 301. The coupling assembly 301 can be actuated automatically or manually. When engaged, the coupling assembly 301 can create a mechanical path that bypasses the generator 330 and the traction motor 310 such that the mechanical energy is used directly to drive or propel the bike 100. The coupling assembly 301 can be actuated to selectively physically couple the crank assembly 160 with the traction assembly 170 at desired times (e.g., no battery power, need additional torque, etc.). The electrical connection between the crank assembly 160 and the traction assembly 170 can remain constant, while the mechanical connection can be intermittent.

The drive unit 155 can include at least one crank assembly 160. The crank assembly 160 can include at least one pedal assembly 195. The crank assembly 160 can receive mechanical power from a user via the pedal assembly 195. For example, the pedal assembly 195 can include a pedal 196 and a shaft 197. The pedal 196 can be rotatably coupled to the shaft 197 and configured to rotate relative to the shaft 197. The crank assembly 160 can include at least one clutch 315. The clutch 315 can be mechanically coupled with the pedal assembly 195. The clutch 315 can be a one-way clutch or a two-way clutch, for example. The crank assembly 160 can include at least one geartrain, shown as first geartrain 320. The clutch 315 can engage a first geartrain 320. For example, the clutch 315 can selectively engage the first geartrain 320 when a user moves the pedal assembly 195 in a predetermined direction. The first geartrain 320 can include any number of gears disposed in any configuration. The first geartrain 320 can be a single speed geartrain. For example, the first geartrain 320 can have a fixed ratio. The shaft 197 of the pedal assembly 195 can be operatively coupled to the first geartrain 320. For example, rotation of the shaft 197 can cause the first geartrain 320 or a portion thereof to rotate. Such operative coupling of the shaft 197 with the first geartrain 320 of the crank assembly 160 can allow a user to mechanically rotate the first geartrain 320 by applying a mechanical input to the pedal 196 to rotate the shaft 197.

The crank assembly 160 can include the generator 330. The generator 330 can be or include a reversible electromechanical device that can convert mechanical energy into electrical energy (acting as a generator) or electrical energy into mechanical motion (acting as a motor). For example, in a series hybrid bike 100, the generator 330 can be connected to the pedals 196, such that it can harvest power from pedaling.

The crank assembly 160 can include or be operatively coupled with the battery 215. The mechanical input provided by the user via the pedal assembly 195 (e.g., via the pedal 196 of the pedal assembly 195) can be transferred to the generator 330 via the clutch 315 and the first geartrain 320. For example, the first geartrain 320 can be mechanically coupled with the generator 330. The generator 330 can convert the mechanical power provided via the first geartrain 320 (e.g., power provided by the user via the pedal assembly 195) into electrical power. The electrical power can be stored in the battery 215 or can be transferred to another component of the bike 100 (e.g., the traction motor 310) to power another component of the bicycle 100. As such, the crank assembly 160 can provide power from the pedal assembly 195 to at least one of the generator 330, battery 215, or the traction assembly 170. Operating the generator 330 as a motor can cause the first geartrain 320 to move, which can further cause the pedal assembly 195 of the crank assembly 160 (to which the first geartrain 320 is coupled) to move. In this way, the generator 330 can actuate the pedal assembly 195 or a portion thereof (e.g., the pedal 196, the shaft 197, or some other portion of the pedal assembly 195).

The drive unit 155 can include at least one electrical conduit, shown as electrical bus 325. The bus 325 can be an electrically conductive member that can conduct electricity to electrically couple the crank assembly 160 with traction assembly 170. The crank assembly 160 can be constantly electrically coupled with the traction assembly 170. For example, the bus 325 can create a permanent electrical connection between the crank assembly 160 and the traction assembly 170. Electrical power can transfer from the generator 330 or battery 215 to the traction assembly 170 via the bus 325.

The traction assembly 170 can include at least one traction motor 310. The bus 325 can electrically couple at least one of the generator 330 or the battery 215 with the traction motor 310 of the traction assembly 170. The electrical power created by the generator 330 or stored by the battery 215 can be transferred to the traction motor 310 via the bus 325. As such, the traction assembly 170 can receive the electrical power from at least one of the generator 330 or the battery 215 and drive the wheel 140 of the bike 100 using the electrical power received. For example, the traction motor 310 can convert the electrical power to mechanical power. The traction motor 310 can be mechanically coupled with another geartrain, shown as a second geartrain 335. The traction motor 310 can use the electrical power received via the bus 325 to drive the second geartrain 335.

The bike 100 can include at least one drivetrain 172 operatively coupling the drive unit 155 with the wheel 140 of the bike 100. For example, the drivetrain 172 can be coupled with or be a part of the traction assembly 170. The drivetrain 172 can mechanically couple the drive unit 155 with the wheel 140 of the bicycle 100 such that operation of the drive unit 155 can cause the wheel 140 to rotate to propel the bike 100, for example. The drivetrain 172 can be or include a chain or belt. The drivetrain 172 can extend between and mechanically couple the traction assembly 170, and thus the drive unit 155, with the wheel 140. For example, the drive unit 155 can be disposed away (e.g., spaced apart from) the wheel 140 with the drivetrain 172 extending between the traction assembly 170 and the wheel 140. The drivetrain 172 can transfer mechanical power from the drive unit 155 (e.g., power originating from the user applying a force to the crank assembly 160 via the pedal assembly 195 or power from the battery 215) to the wheel 140 to drive the bike 100. The drivetrain 172 can be mechanically coupled with the second geartrain 335 of the traction assembly 170. The drivetrain 172 can receive mechanical power from the traction motor 310 of the traction assembly 170 via the second geartrain 335. The drive unit 155 can be constantly or permanently mechanically coupled with the second geartrain 335. For example, the mechanical connection between the drivetrain 172 and the second geartrain 335 can remain constantly intact.

The drive unit 155 can include at least one coupling assembly 301. The coupling assembly 301 can selectively mechanically couple the crank assembly 160 with the traction assembly 170 (e.g., the drivetrain 172). With the crank assembly 160 mechanically coupled with the traction assembly 170, the traction assembly 170 can receive power directly from the pedal assembly 195 of the crank assembly 160. The coupling assembly 301 can be or include a clutch 340. The clutch 340 can selectively engage or disengage the crank assembly 160 and the traction assembly 170. For example, the clutch 340 can selectively mechanically couple the first geartrain 320 of the crank assembly 160 with the drivetrain 172 of traction assembly 170. The clutch 340 can be actuated manually or automatically to engage and disengage the coupling assembly 301 to selectively mechanically couple the crank assembly 160 with the traction assembly 170. For example, the coupling assembly 301 can be coupled with an electromechanical actuator. A user of the bicycle 100 can actuate the clutch 340 of the coupling assembly 301 via the electromechanical actuator. The coupling assembly 301 can be coupled with the control device 190. The control device 190 can automatically actuate the clutch 340. For example, the control device 190 can automatically actuate the clutch 340 based on riding conditions (e.g., bicycle speed, pedal speed, etc.). The control device 190 can be a part of or coupled with the drive unit 155. In other examples, the control device 190 can be associated with the bike 100 generally and can be communicably coupled with a control device (e.g., a controller, a printed circuit board assembly, or some other control device) that is part of the drive unit 155 specifically. In either case, the control device 190 can control or actuate the coupling assembly 301 to engage or disengage the crank assembly 160 and the traction assembly 170.

With the coupling assembly 301, the drive unit 155 can switch between a first configuration and a second configuration. In the first configuration, the crank assembly 160 can be only electrically coupled with the traction assembly 170. For example, the only connection between the crank assembly 160 and the traction assembly 170 in the first configuration is the electrical connection via the electrical bus 325. In the first configuration, the coupling assembly 301 does not form a mechanical connection between the crank assembly 160 and the traction assembly 170. In the second configuration, the crank assembly 160 can be both electrically and mechanically coupled with the traction assembly 170. For example, in the second configuration the coupling assembly 301 can create a mechanical connection between the crank assembly 160 and the traction assembly 170 with the crank assembly 160 still electrically coupled with the traction assembly 170 via the electrical bus 325. For example, the coupling assembly 301 can selectively couple the first geartrain 320 of the crank assembly 160 with the drivetrain 172 of traction assembly 170.

The first configuration can represent a series configuration of the drive unit 155 (e.g., a series hybrid system). For example, all of the power to drive the bike 100 can follow a single path. For example, power can initiate at the pedal 196 of the pedal assembly 195. The power can be a first mechanical power. The first mechanical power can transfer from the pedal assembly 195 to a generator 330. The generator 330 can convert the first mechanical power to electrical power. The electrical power can be transferred to the traction motor 310 of the traction assembly 170 via the bus 325. The traction motor 310 can convert the electrical power to a second mechanical power. The second mechanical power can be transferred from the traction motor 310 to the drivetrain 172. The drivetrain 172 can be coupled with a traction element (e.g., wheel 140) of the bike 100. For example, the drivetrain 172 can be coupled with the rear wheel 140 (e.g., the second wheel), such that traction motor 310 drives the rear wheel 140 via the drivetrain 172 to propel the bike 100 in a desired direction. In this way, the second mechanical power provided to the drivetrain 172 can cause the drivetrain 172 to drive the traction element and ultimately drive the bike 100.

The traction motor 310 can operate in a generator mode to perform regenerative braking. During regenerative braking, kinetic energy of the rotating rear wheel 140 can become a source of power. As the rider makes a brake input, the rear wheel 140 can transfer mechanical torque through the drivetrain 172 back to the traction motor 310. The traction motor 310 can convert the mechanical energy from the drivetrain 172 into electrical energy. For example, the mechanical energy from the drivetrain 172 can rotate a rotor of the traction motor 310 within a stator. Such rotation of the rotor within the stator can generate electrical current. The act of generating electricity can create an electromagnetic resistance in the traction motor 310, which produces a resistive torque opposing the rotation of the rear wheel 140. The resistive torque can slow the bike 100 while generating electrical power. In this way, the traction motor 310 can function as at least one component of a brake system of the bike 100. The traction motor 310 can provide brake force to the bike 100, with or without additional brake elements, such as friction brakes. For example, the traction motor 310 can be the sole component of the bike 100 providing resistive force to slow the bike based on receiving a brake input (e.g., actuating the brake controller 118) from the user.

The second configuration can represent a parallel configuration of the drive unit 155 (e.g., a parallel hybrid system). For example, the power to drive the bike 100 can flow through separate paths. A first path can include transferring power from the pedal assembly 195 to the generator 330 and the traction motor 310 before the power reaches the drivetrain 172. The second path can include transferring power from the pedal assembly 195 directly to the drivetrain 172 (e.g., without the power being converted into electrical energy). For example, the coupling assembly 301 can mechanically couple the crank assembly 160 with the drivetrain 172 such that the generator 330 and traction motor 310 are bypassed. In the second configuration, the first mechanical power generated by the pedal assembly 195 can be directly applied to the drivetrain 172 without first being converted to electrical power and then being converted back to a second mechanical power. In the second configuration, the power provided by the pedal assembly 195 can be transferred to the drivetrain 172 in various combinations. For example, the pedal assembly 195 can provide a first mechanical power. A first portion of the first mechanical power can be transferred directly to the drivetrain 172. A second portion of the first mechanical power can be transferred to the generator 330 and the traction motor 310, and converted into a second mechanical power, prior to reaching the drivetrain 172. The first portion of the first mechanical power can be greater than, less than, or equal to the second portion, and can vary according to an operation of the bike 100, an input of the user, or otherwise.

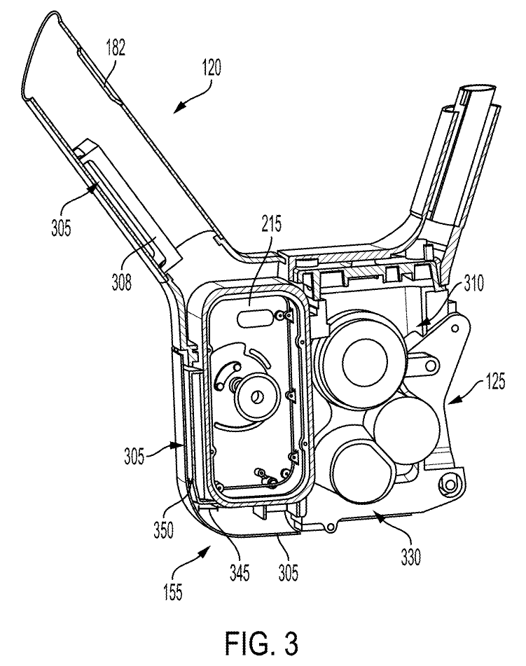

As shown in FIGS. 3-5, among others, a brake system 125 of the bike 100 can include the drive unit 155 and at least one resistor 305. The resistor 305 can receive energy (e.g., electrical energy). For example, the resistor 305 can receive energy generated by the traction motor 310 during regenerative braking. The resistor 305 can receive energy generated by the generator 330, or by some other component of the bike 100. The resistor 305 can be disposed in the housing 205 of the drive unit 155. The resistor 305 can be positioned within the housing 205 of the drive unit 155 or outside of the drive unit 155. For example, the resistor 305 can couple with the battery 215. The resistor 305 can couple with a front side of the battery 215. For example, the resistor can be positioned on a side of the battery 215 facing a front wheel 140 of the bike 100. The resistor can be positioned on a bottom of the battery 215 (e.g., facing the ground). The resistor 305 can be disposed in a frame member (e.g., the down tube 182) of the frame 120. The resistor 305 can be disposed in or coupled with other members of the frame 120. The resistor 305 can couple with various components of the bike 100. The resistor 305 can couple with the traction motor 310 or the generator 330.

For example, a first resistor 306 can be positioned within the drive unit 155. The first resistor 306 can be positioned such that it is adjacent to the inner surfaces of the housing 205. For example, the first resistor 306 can couple with a housing of the battery 215, such that the first resistor 306 is positioned between the housing 205 and the battery 215. The first resistor 306 may be mounted by at least one of its edges to the housing of the battery 215. The first resistor 306 can be spaced a first distance 345 away from the battery 215. The first distance 345 can create an airgap between the housing of the battery 215 and at least a portion of the first resistor 306. The first resistor 306 can be spaced a second distance 350 away from the housing 205 of the drive unit 155. The second distance 350 can create an airgap between the housing 205 of the drive unit 155 and at least a portion of the first resistor 306. The first distance 345 can be the same as, or different from the second distance 350. For example, the second distance 350 can be greater than the first distance 345, or the first distance 345 can be greater than the second distance 350.

The first resistor 306 can be or include a printed circuit board (PCB) having one or more resistive devices 500. The resistive devices 500 can be or include surface mount device (SMD) resistors, through-hole resistors, variable resistors, or some other type of resistive device. The first resistor 306 can be communicatively coupled with the control device 190, such that the first resistor 306 can receive electrical power from the traction motor 310, or from some other component, based on a signal from the control device 190. The first resistor 306 can have a first capacity. The capacity of the resistor can be a maximum amount of power (e.g., measured in Watts) that the resistor can dissipate as heat over time. The first resistor 306 can have, for example, a first capacity between .5kW and 3kW, between 1 kW and 2kW, or >2kW.

A second resistor 307 can be positioned within the drive unit 155. The second resistor 307 can be of the same type or a different type from the first resistor 306. The second resistor 307 can be positioned within the drive unit 155. The second resistor 307 can be positioned such that it is adjacent to the inner surfaces of the housing 205. For example, the second resistor 307 can couple with a housing of the battery 215, such that the second resistor 307 is positioned between the housing 205 and the battery 215. The second resistor 307 can be spaced the first distance 345 away from the battery 215. The first distance 345 can create an airgap between the housing of the battery 215 and at least a portion of the second resistor 307. The second resistor 307 can be spaced a second distance 350 away from the housing 205 of the drive unit 155. The second distance 350 can create an airgap between the housing 205 of the drive unit 155 and at least a portion of the second resistor 307. The first distance 345 can be the same as, or different from the second distance 350. For example, the second distance 350 can be greater than the first distance 345, or the first distance 345 can be greater than the second distance 350.

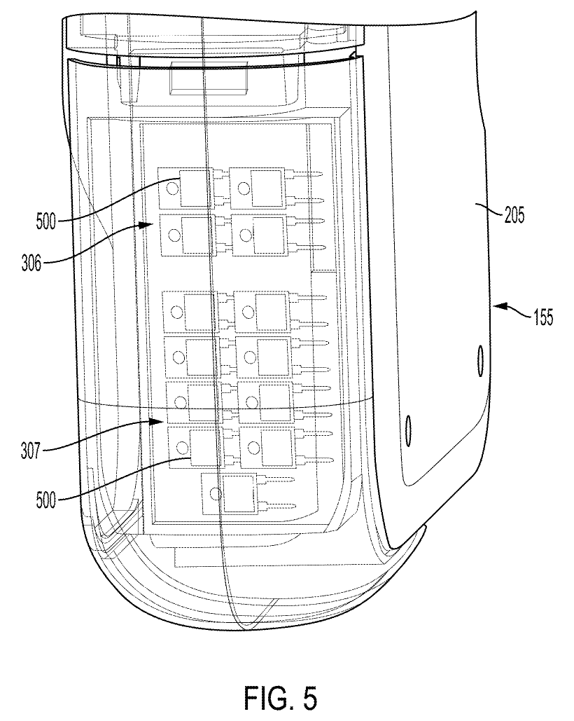

The second resistor 307 can be or include a printed circuit board (PCB) having one or more resistive devices 500. As shown in FIG. 5, among others, the second resistor 307 and the first resistor 306 may share a PCB. For example, the first resistor 306 can include a first bank of resistive devices 500 and the second resistor 307 can include a second bank of resistive devices 500. The second resistor 307 may include one or more resistive devices 500 positioned on a different PCB from the first resistor 306. The second resistor 307 can be communicatively coupled with the control device 190, such that the second resistor 307 can receive electrical power from the traction motor 310, or from some other component, based on a signal from the control device 190. The second resistor 307 can have a second capacity. The second resistor 307 can have, for example, a second capacity between .5kW and 3kW, between 1 kW and 2kW, or >2kW. The second capacity can be the same as or different from the first capacity. For example, the second resistor 307 can have a greater capacity then the first resistor 306 or a lower capacity than the first resistor 306.

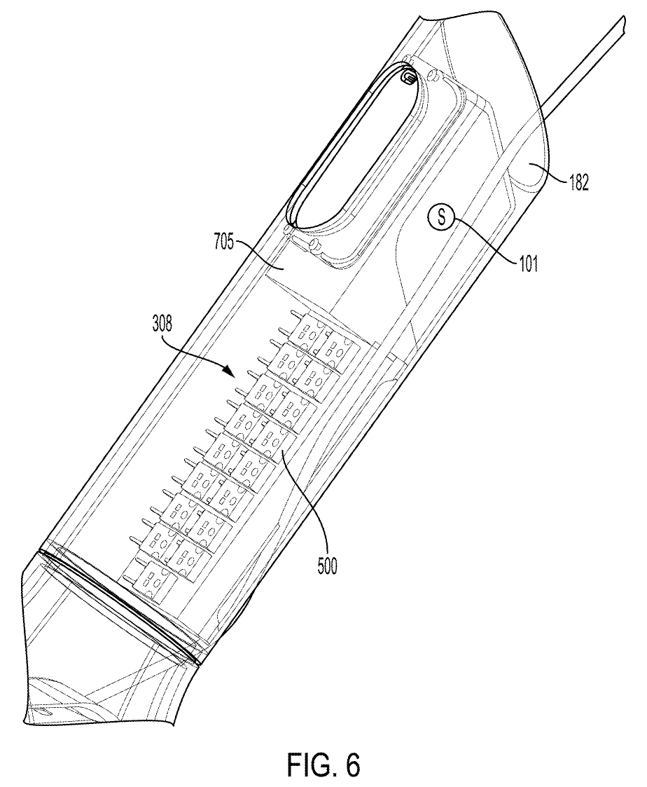

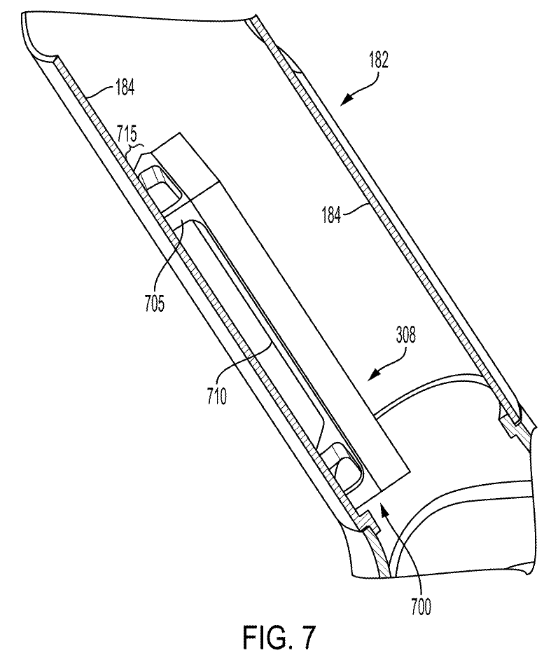

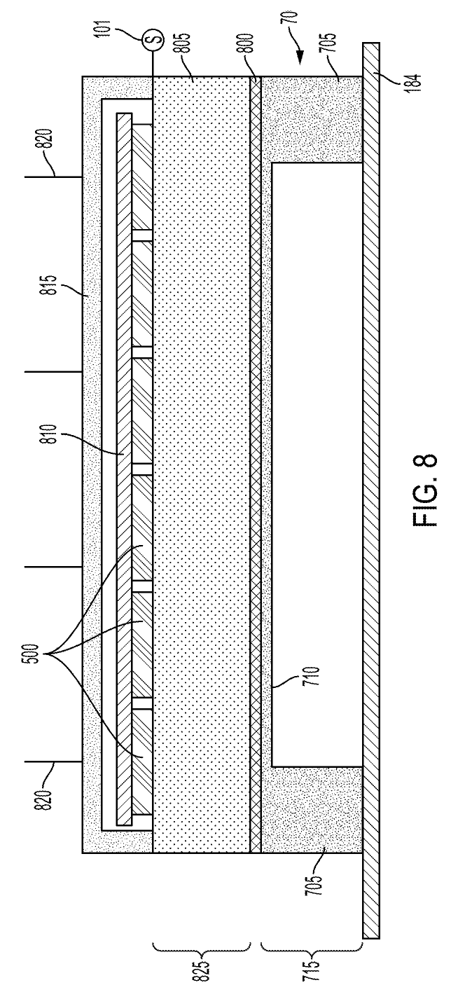

As shown in FIGS. 6-8, among others, third resistor 308 can be positioned remote relative to the drive unit 155. For example, the third resistor 308 can be positioned within the frame 120. As shown in FIGS. 6 and 7, among others, the third resistor 308 can be positioned within the down tube 182. The third resistor 308 can couple with a stand 700 having a base 710 and at least one leg 705 extending from the base 710. The third resistor 308 can couple with the base 710. The leg 705 can couple with an interior surface 184 of the down tube 182. The third resistor 308 can be spaced apart from the interior surface 184 by a distance 715. The distance 715 may be the height of the legs 705. The third resistor 308 can couple with a harness or some other structural element that suspends the third resistor 308 within the interior volume of the down tube 182. The third resistor 308 can have a third capacity. The third resistor 308 can have a third capacity. The third resistor 308 can have, for example, a third capacity between .5kW and 10kW, between 2 kW and 8kW, between 4kW and 6kW, or >6kW. The third capacity can be different from or the same as the first capacity or the second capacity. The third capacity can be greater than both the first capacity and the second capacity, such that the third resistor 308 has the largest capacity of the resistors 305 within the brake system 125.

The third resistor 308 can include at least one resistive device 500. The resistive device 500 can receive electrical power generated by the traction motor 310 (e.g., during regenerative braking) and convert such electrical power to heat. The resistive device 500 can be mounted to a PCB 810. The resistive device 500 can be or include surface mount device (SMD) resistors, through-hole resistors, variable resistors, or some other type of resistive device. Additionally or alternatively, the resistive device 500 can be or include a nickel and chromium alloy (nichrome) wire formed in a coil. The nichrome wire coil can receive the electrical power generated by the traction motor 310 (e.g., during regenerative braking) and convert such electrical power to heat. The nichrome wire coil can be coupled with an electrical switch or a downstream electrical path control device rather than the PCB 810.

A heat sink structured as a thermal mass 805 can be coupled with the resistive device 500, such that the resistive device 500 is positioned between the PCB 810 and the thermal mass 805. The thermal mass 805 can be structured to absorb and to dissipate heat generated by the resistive device 500. The thermal mass 805 can be comprised or iron, an iron alloy, aluminum, or an aluminum alloy, among others. The thermal mass 805 can have a thickness 825. The thickness 825 can be similar to or the same as the distance 715 defined by the height of the legs 705. The thickness 825 can be less than or greater than the distance 715. The thickness 825 of the thermal mass 805 can depend on the capacity of the third resistor 308. For example, the thickness 825 of the thermal mass 805 can increase as a function of the capacity of the third resistor 308. A second heat sink, shown as heat sink 815 can couple with the thermal mass 805. The PCB 810 and the resistive device 500 can be positioned between the thermal mass 805 and the heat sink 815. The heat sink 815 can be or include a device or component that absorbs and dissipates heat from another object, such as the resistive device 500, the thermal mass 805, or other components of the third resistor 308. The heat sink 815 can conduct heat away from the resistive device 500 and the PCB 810 and releasing it into the surrounding environment, for example, conduction or convection. The heat sink 815 can include at least one fin 820. The fin 820 can be a protruding surface that increases a total surface area of the heat sink 815, thereby enhancing the dissipation of heat into the surrounding environment. The heat sink 815 can be or include a vapor chamber. The vapor chamber can be or include a sealed, heat-transfer structure that utilizes phase change (e.g., from liquid to gas, from gas to liquid, among others) of an internal working fluid to spread heat across its surface before the heat transfers to the walls of the heat sink 815 and to the fin 820.

The third resistor 308 can include an insulating layer 800. The insulating layer 800 can be positioned between the base 710 of the stand 700 and the heat sink, shown as the thermal mass 805. The insulating layer 800 can be made of plastics, plastic composites, foam, or any porous material having a density less than a predefined low density threshold. The insulating layer 800 can limit heat transfer between the thermal mass 805 and one or more other elements. For example, the insulating layer 800 can limit heat transfer between the thermal mass 805 and the stand 700. In this way, the stand 700 can receive less heat than is stored in the thermal mass 805. Beneficially, mitigating the amount of heat the stand 700 receives can mitigate the heat transferred from the legs 705 to the down tube 182 via the connection between the legs 705 and the interior surface 184 of the down tube 182. In this way, the layers of the third resistor 308 can limit formation of hot spots on the down tube 182 (e.g., spots that may be uncomfortable or too hot for a user to touch).

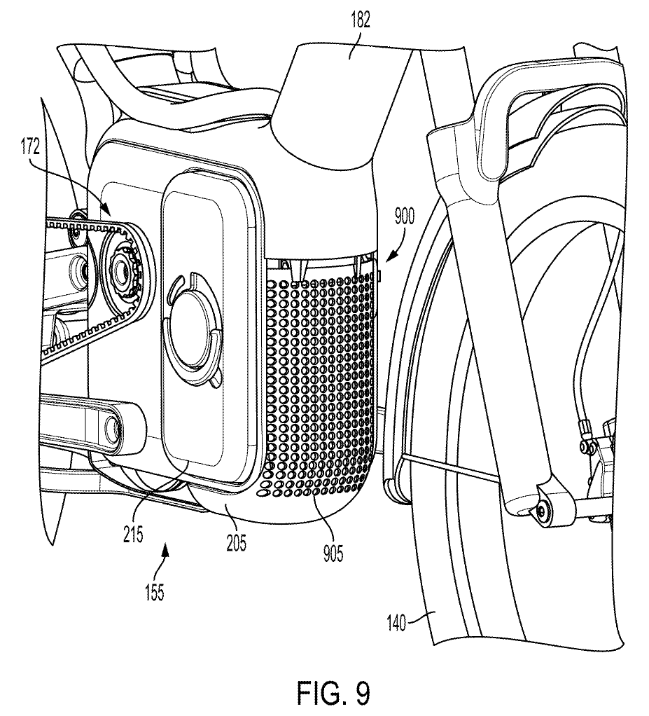

FIG. 9 depicts a perspective view of the drive unit 155 of the bike 100. The housing 205 of the drive unit 155 can include at least one opening 905. The opening 905 can allow air to flow into the interior of the housing 205, such that ambient air can receive heat from the components within the drive unit 155. The housing 205 can include a front side 900 positioned adjacent to/inline with the front wheel 140. The front side 900 of the 205// can include the opening 905. The first resistor 306 and the second resistor 307 can be positioned such that they are aligned with the front side 900 of the housing 205. In this way, air can flow into the interior of the housing 205 of the drive unit 155 and dissipate at least a portion of the heat generated by the first resistor 306 and the second resistor 307.

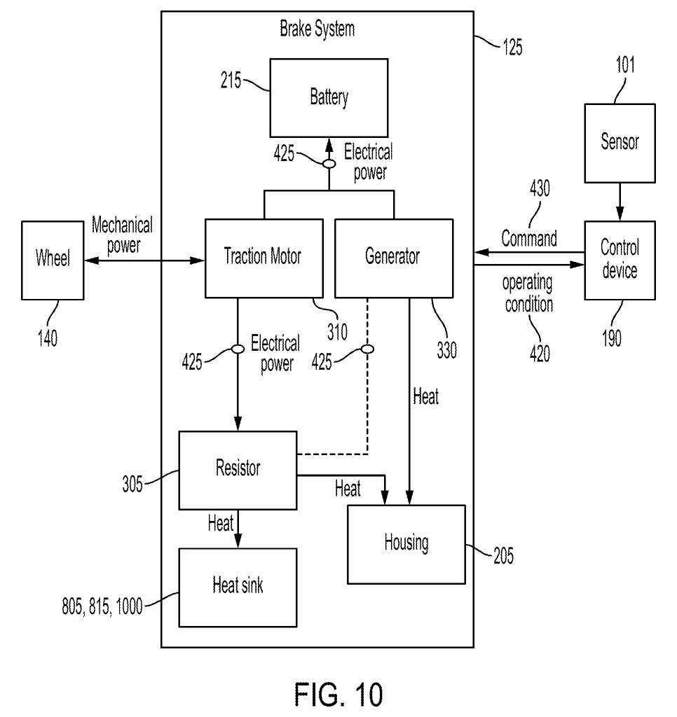

As shown in FIG. 10, among others, a heat sink 1000 can couple with at least one of the first resistor 306 or the second resistor 307.The heat sink 1000 can receive heat from the first resistor 306 or the second resistor 307. The heat sink 1000 can be any material configured to receive heat from the resistors 306, 307. The heat sink 1000 can be at least partially disposed in the housing 205 of the drive unit 155. The heat sink 1000 can be positioned between the resistors 306, 307 and the front side 900 of the housing 205 such that the opening 905 is aligned with the heat sink 1000. The heat sink 1000 can be at least partially disposed outside of the housing 205. For example, the heat sink 1000 can be coupled with or include fins or other features that are disposed at least partially outside the housing 205 to facilitate convection and transfer of the heat from the heat sink 1000 to the surrounding environment. The opening 905 can be sized to receive a portion of the fins or other features. For example, the heat sink 1000 can include at least one fin that extends away from the surface of the heat sink 1000 and through the opening 905. The heat sink 1000 can be or include a vapor chamber. The vapor chamber can be or include a sealed, heat-transfer structure that utilizes phase change (e.g., from liquid to gas, from gas to liquid, among others) of an internal working fluid to spread heat across its surface before the heat transfers to the walls of the heat sink 1000 and to fins or other features extending from the heat sink 1000.

Other components of the bike 100 or brake system 125 can receive heat that is generated from the electrical power induced by braking the bike 100. For example, the traction motor 310, the generator 330, or the housing 205 of the drive unit 155, among other components, can receive heat generated by the traction motor 3610 when braking the bike 100. The traction motor 310, the generator 330, the housing 205, and other components can dissipate at least some of the heat generated by the traction motor 310 to the surrounding environment.

The surfaces of the bike 100 that are heated by the resistors 305 can be selected based on user accessibility, exposure to air flow during operations, or other parameters. For example, the resistors 305 can be positioned within portions of the bike 100 that are not typically hand or leg contact points for a user. For example, the resistors 305 can be positioned adjacent to an interior surface of the fork 145, adjacent to a rear surface of the top tube 185, within the traction assembly 170, or within some other portion of the bike 100 that is typically not touched by the user. The resistors 305 can be positioned within portions of the bike 100 that are not shielded from, or are lightly shielded from, airflow generated by the forward motion of the bike 100 during operation. For example, the resistors 305 can be positioned such that they are adjacent to forward facing surfaces of the bike 100. As shown in FIG. 9, at least one resistor 305, can be positioned adjacent to the front side 900 of the housing 205 of the drive unit 155 rather than adjacent to a rear side of the housing 205 to increase the airflow the surface heated by the resistor 305 is exposed to.

FIG. 10 depicts a schematic diagram of an example brake system 125. The brake system 125 can convert mechanical energy into electrical energy, and can convert electrical energy into heat to facilitate braking of the bike 100. The brake system 125 can include the traction motor 310. The traction motor 310 can receive electrical power from a battery 215. The traction motor 310 can convert the electrical power to mechanical power to drive a wheel 140 of the bike 100. For example, the traction motor 310 can transmit mechanical power through the drivetrain 172 to drive the rear wheel 140, thereby propelling the bike 100. The traction motor 310 can receive mechanical power from the second wheel 140 of the bike 100 via the drivetrain 172 to reduce the speed of the bike 100. For example, the traction motor 310 can exert a resistive torque on the second wheel 140 via the drivetrain 172 by operating in a generator mode. The traction motor 310 can operate in a generator mode to perform regenerative braking. During regenerative braking, kinetic energy of the rotating rear wheel 140 becomes the initial source of power. As the rider makes a brake input, the rear wheel 140 can transfer mechanical torque through the drivetrain 172 back to the traction motor 310. The traction motor 310 can convert the mechanical energy from the drivetrain 172 into electrical energy. For example, the mechanical energy from the drivetrain 172 can rotate a rotor of the traction motor 310 within a stator. Such rotation of the rotor within the stator can generate electrical current. The act of generating electricity can create an electromagnetic resistance in the traction motor 310, which produces the resistive torque opposing the rotation of the rear wheel 140. The resistive torque can slow the bike 100 while generating electrical power.

The brake system can include at least one control device 190. The control device 190 can distribute electrical power to different components of the bike 100. For example, the control device 190 can cause the battery 215 can receive electrical power generated by the generator 330 or by the traction motor 310. The control device 190 can cause the resistor 305 to receive electrical power generated by the traction motor 310, for example. The control device 190 can determine where to send the electrical power based on an operating condition 420 of the component. The operating condition 420 can be, for example, a state of charge of a battery 215, a temperature of the resistor 305, a temperature of a heat sink 805, 815, 1000, a temperature of the drive unit 155, a temperature of the down tube 182, or a size or capacity of a resistor, among others.

The control device 190 can direct electrical power to a battery 215 based on a state of charge of the battery 215. The battery 215 can be coupled at least one sensor 101 or a battery management device configured to collect data indicative of the state of charge of the battery 215. The state of charge (SOC) can measure of how much energy is stored in a battery 215 relative to its total capacity, expressed as a percentage (0% = fully discharged, 100% = fully charged. The control device 190 can detect the SOC of the battery 215. For example, the control device 190 can detect the SOC of the battery 215 directly, or based on data the control device 190 receives from the sensor 101 or the battery management system. The control device 190 can compare the SOC of the battery 215 to a SOC threshold. The SOC threshold can be an SOC value or values below which the control device 190 will direct electrical power to the battery 215 generated by the traction motor 310 through regenerative braking or by the generator 330 through converting pedaling energy, and above which, the control device 190 will not direct electrical power generated by the traction motor 310 or the generator 330. For example, the control device 190 can operate one or more components of the brake system 125 to direct at least some of the electrical energy from the traction motor 310 and the generator 330 to the battery 215 to charge the battery 215 based on the state of charge of the battery 215 being less than the SOC threshold.

If the SOC of the battery 215 is greater than the SOC threshold, the control device 190 can cause the generator 330 to stop generating electrical power based on mechanical inputs from the user via the pedal 196. For example, the control device 190 cease transmission of an excitation current to the generator 330 to cause the generator 330 to stop generating electrical power. The control device 190 can operate the clutch 315 to disconnect the pedal assembly 195 from the first geartrain 320 to stop transmission of mechanical inputs from the user via the pedal 196 to the generator 330. In this way, operating the clutch 315 to disconnect the pedal assembly 195 from the first geartrain 320 can cause the generator 330 to stop generating electrical power. The generator 330 can be coupled with at least one resistor 305, such that the resistor 305 can receive electrical power from the generator 330. The control device 190 can direct the electrical power generated by the generator 330 to the resistor 305 based on the SOC of the battery 215 being greater than the SOC threshold.

If the SOC of the battery 215 is greater than the SOC threshold, the control device 190 can direct the electrical power generated by the traction motor 310 through regenerative braking to at least one resistor 305. The control device 190 can divide the electrical power evenly between the resistors 305. For example, the control device 190 can transmit an equal amount of the electrical power generated by the traction motor 310 to the first resistor 306, the second resistor 307, and the third resistor 308.

The control device 190 can direct electrical power to a resistor 305 based on a capacity of the resistor 305. For example, the control device 190 can determine or detect an amount of electrical power being generated by the traction motor 310 during regenerative braking and can determine which resistor 305 to route the electrical power generated by the traction motor 310 to based on the capacity of each resistor 305. The control device 190 can direct all or a subset of the electrical power to the resistor 305 based on a capacity of the resistor 305. The control device 190 can proportionally divide the electrical power between the resistors 305 based on relative capacities of the resistors 305. For example, the control device 190 can direct all of the electrical load to a resistor 305 whose capacity is greater than or equal to the amount of electrical power being transmitted. The resistors 305 may have a dynamically defined hierarchy. For example, if the electrical power is less than or equal to the capacities of multiple resistors, the control device 190 choose to route the electrical power to the first resistor 306 rather than the second resistor 307 or the third resistor 308, to the second resistor 307 rather than the first resistor 306 or the third resistor 308, or to the third resistor 308 rather than the first resistor 306 or the second resistor 307. If the electrical power is less than the capacity of one resistor, such as the third resistor 308, but greater than the capacity of each of the remaining resistors 305 (e.g., the first resistor 306 and the second resistor 307), then the control device 190 may direct the all of electrical power to the one resistor, such as the third resistor 308, rather than dividing the electrical power among the resistors 305.

If the electrical power is greater than the first capacity of the first resistor 306, but less than the combined capacity of the first resistor 306 and the second resistor 307, the control device 190 can direct a first portion of the electrical power to the first resistor 306 and a second portion/remainder of the electrical power to the second resistor 307. If the electrical power is greater than the combined capacity of the first resistor 306 and the second resistor 307, the control device 190 can direct a first portion of the electrical power to the first resistor 306, a second portion of the electrical power to the second resistor 307, and a third/remaining portion of the electrical power to the third resistor 308.

The control device 190 can determine which resistors 305 to direct the electrical power to based on a temperature of a corresponding heat sink 805, 815, 1000, a temperature of the drive unit 155, a temperature of the housing 205 of the drive unit 155, or a temperature of the down tube 182, among others. For example, the control device 190 can receive data indicative of temperatures of the drive unit 155 or of the components therein from one or more sensors 101 structured as temperature sensors. The control device 190 can receive data indicative of the temperature of the heat sinks 805, 815, 1000, or the resistors 305 themselves from one or more sensors 101 structured as temperature sensors. The control device 190 can receive data indicative of a temperature of the frame 120, a portion of the frame 120, such as the down tube 182, or a portion of the down tube 182 positioned adjacent to the third resistor 308 from one or more sensors 101 structured as temperature sensors.

The control device 190 can determine which resistors 305 to use based on inferred temperature values calculated based on operational factors. For example, the control device 190 may estimate the thermal dissipation capacity of the resistors 305 based on ambient temperature, bike speed, airflow exposure, duration of recent braking events, or other operational factors. The control device 190 can receive data indicative of an ambient temperature from one or more sensors 101, by user input, or from a third party data provider (e.g., a weather service, etc.). The control device 190 can receive data indicative of the speed of travel of the bike from one or more sensors 101 structured as velocity sensors. Higher speeds may be associated with increased convective cooling, allowing the control device 190 to route more electrical power to a resistor 305 positioned in a high-airflow region. Low-speed operation or high ambient temperatures can cause slower dissipation of heat from the resistors 305 to the ambient environment. In such conditions, the control device 190 can distribute electrical power to resistors located in cooler or better-cooled sections of the bike 100. Additionally, or alternatively, in such conditions, the control device 190 can distribute electrical power between all of the resistors 305, rather than to a single resistor 305 with sufficient capacity to dissipate the load. This distribution can cause each resistor 305 to output a lower amount of heat to be transferred to the ambient environment rather than causing one resistor 305 to output a greater amount of heat.

The control device 190 can direct the electrical power generated by the traction motor 310 to the first resistor 306, to the second resistor 307, or to both the first resistor 306 and the second resistor 307 based on the temperature of the drive unit 155, or a component therein, being less than a first temperature threshold. For example, if the temperature of the housing 205 of the drive unit 155 adjacent to the first resistor 306 and the second resistor 307 is less than the first temperature threshold, then the control device 190 can direct at least a portion of the electrical power to the first resistor 306, to the second resistor 307, or to both the first resistor 306 and the second resistor 307. If the temperature of the first resistor 306 or the heat sink 1000 is less than the first temperature threshold, then the control device 190 can direct at least a portion of the electrical power to the first resistor 306. If the temperature of the second resistor 307 or the heat sink 1000 is less than the first temperature threshold, then the control device 190 can direct at least a portion of the electrical power to the second resistor 307. The first temperature threshold can be, for example, 100-300℃, 150-250℃, 200℃, or >200℃ . If the drive unit 155, or a component therein, has a temperature greater than the first temperature threshold, then the control device 190 can, for example, direct the electrical power generated by the traction motor 310 during regenerative braking to the third resistor 308.

The control device 190 can direct the electrical power generated by the traction motor 310 to the third resistor 308 based on the temperature of the thermal mass 805, a temperature of the heat sink 815, a temperature of the third resistor 308, or a temperature of the down tube 182 positioned adjacent to the third resistor 308, among others, being less than a second temperature threshold. For example, if the temperature of the down tube 182 adjacent to the third resistor 308 is less than the second temperature threshold, then the control device 190 can direct at least a portion of the electrical power to the third resistor 308. If the temperature of the third resistor 308 is less than the second temperature threshold, then the control device 190 can direct at least a portion of the electrical power to the third resistor 308. If a temperature of the thermal mass 805 or a temperature of the heat sink 815, or a temperature of both the thermal mass 805 and the heat sink 815 is less than the second threshold, then the control device 190 can direct at least a portion of the electrical power to the third resistor 308. The second temperature threshold may be the same as or different from the first temperature threshold. The second temperature threshold can be, for example, 100-300℃, 150-250℃, 200℃, or >200℃ . If the portion of the down tube 182 positioned adjacent to the third resistor 308, the third resistor 308, the thermal mass 805, or the heat sink 815, or a combination thereof, has a temperature greater than the second temperature threshold then the control device 190 can, for example, direct the electrical power generated by the traction motor 310 during regenerative braking to the first resistor 306, the second resistor 307, or to both the first resistor 306 and the second resistor 307.

The brake system 125 can include at least one electrical junction, shown as switch 425. The switch 425 can move between positions to allow or prevent electrical power from reaching the target component of the brake system 125. For example, the switch 425 can be between the traction motor 310 and the battery 215. The control device 190 can generate and transmit a command 430 to control the switch 425. For example, the control device 190 can detect that a battery 215 is not fully charged. The control device 190 can generate a first command 430 to actuate the switch 425 such that electrical power can pass from the traction motor 310 to the battery 215. The control device 190 can detect that the state of charge of the battery 215 is greater than the SOC threshold and generate a second command 430 to actuate the switch 425 such that electrical power cannot pass from the traction motor 310 to the battery 215. This can prevent too much electrical power from reaching the battery 215 when the battery does not have capacity to receive additional electrical power.

The brake system 125 can include a switch 425 between the traction motor 310 and the each resistor 305. The control device 190 can generate and transmit a command 430 to control the switch 425. For example, the control device 190 can operate the switch 425 to connect the path between the traction motor 310 and one or more resistors 305 based on the SOC of the battery 215 being greater than the SOC threshold. For example, the control device 190 can identify a resistor 305 with a capacity to receive at least a portion of the electrical power. The control device 190 can generate a first command 430 to actuate the switch 425 such that electrical power can pass from the traction motor 310 to the resistor 305. The control device 190 can detect that the electrical power generated by the traction motor 310 is greater than the capacity of a resistor 305, or that the resistor 305 or corresponding heat sink 805, 815, 1000 has a temperature above a temperature threshold and generate a second command 430 to actuate the switch such that electrical power cannot pass from the traction motor 310 to the resistor 305. This can prevent overworking the resistor 305 and overheating components of the bike 100.

The brake system 125 can include a plurality of switches 425. For example, the brake system 125 can have a first switch 425 between the traction motor 310 and the battery 215. The brake system 125 can have a second switch 425 between the traction motor 310 and the first resistor 306. The brake system 125 can have a third switch 425 between the traction motor 310 and the second resistor 307. The brake system 125 can have a fourth switch 425 between the traction motor 310 and the third resistor 308. The brake system 125 can have any number of switches 425.

As an illustrative example, the brake system 125 can be activated based on an input from a user (e.g., actuation of the brake controller 118). During braking, the traction motor 310 of the bike 100 can convert kinetic energy of the bike 100 into electrical energy and heat to reduce the speed of the bike 100. The control device 190 can distribute the electrical energy generated by the traction motor 310 to various components of the bike 100. For example, the control device 190 can direct the energy to a battery 215 or to a resistor 305.

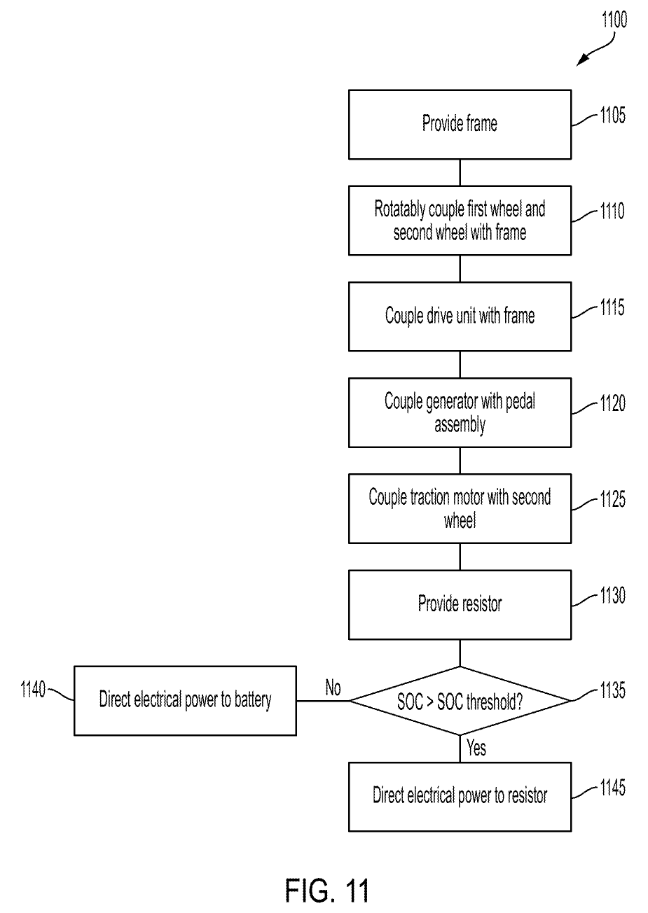

FIG. 11 is a flow diagram of an example method 1100. The method 1100 can include at least one act of providing a frame 120 of a micromobility device, such as the bike 100 (e.g., act 1105). Providing the frame 120 can include manufacturing, assembling, shipping, or otherwise providing the frame 120. The method 1100 can include at least one act of rotatably coupling a first wheel 140 and a second wheel 140 with the frame 120 (e.g., act 1110). For example, the first wheel 140 can rotatably couple with the fork 145 of the bike 100. The second wheel 140 can couple with the traction assembly 170 of the bike 100. The method 1100 can include at least one act of coupling the drive unit 155 with the frame 120 (e.g., act 1115). For example, the drive unit 155 can couple with a middle portion 150 of the frame 120. The drive unit 155 can include a pedal assembly 195. The drive unit 155 can receive mechanical power from a user via the pedal assembly 195. The method 1100 can include at least one act of coupling the generator 330 with the pedal assembly 195 (e.g., act 1120). The generator 330 can convert the mechanical energy exerted on the pedal assembly 195 by a user into electrical power. For example, rotation of the pedal assembly 195 can rotate a rotor of the generator 330 to generate electrical power.

The method 1100 can include at least one act of coupling the traction motor 310 with a wheel 140 of the bike 100 (e.g., act 1125). For example, the traction motor 310 can couple with the rear wheel 140 of the bike. For example, the traction motor 310 can transmit mechanical power through the drivetrain 172 to drive the rear wheel 140 (e.g., the second wheel 140), thereby propelling the bike 100. The traction motor 310 can receive mechanical power from the second wheel 140 of the bike 100 via the drivetrain 172 to reduce the speed of the bike 100. For example, the traction motor 310 can exert a resistive torque on the second wheel 140 via the drivetrain 172 by operating in a generator mode. The traction motor 310 can operate in a generator mode to perform regenerative braking.

The method 1100 can include at least one act of providing at least one resistor 305 (e.g., act 1130). For example, the method 1100 can include providing the first resistor 306, the second resistor 307, and the third resistor 308. For example, the method 1100 can include positioning the first resistor 306 and the second resistor 307 within the drive unit 155. The method 1100 can include positioning the third resistor 308 within the down tube 182 of the bike 100. The method can include at least one act of comparing the SOC of the battery 215 to a SOC threshold (act 1135). For example, the control device 190 can compare the SOC of the battery 215 to a SOC threshold. The SOC threshold can be an SOC value or values below which the control device 190 will direct electrical power to the battery 215 generated by the traction motor 310 through regenerative braking or by the generator 330 through converting pedaling energy, and above which, the control device 190 will not direct electrical power generated by the traction motor 310 or the generator 330. For example, the control device 190 can operate one or more components of the brake system 125 to direct at least some of the electrical energy from the traction motor 310 and the generator 330 to the battery 215 to charge the battery 215 based on the state of charge of the battery 215 being less than or equal to the SOC threshold (e.g., act 1140). If the SOC of the battery 215 is greater than the SOC threshold, then the control device 190 can operate one or more components of the brake system 125 to direct the electrical power generated by the traction motor 310 to the at least one resistor 305 (e.g., act 1145). For example, the control device 190 can operate the switch 425 to direct electrical power from the traction motor 310 to the resistor 305.

The control device 190 can direct the power generated by the generator 330 to the resistor 305 based on the SOC of the battery 215 being greater than the SOC threshold. If the SOC of the battery 215 is greater than the SOC threshold, the control device 190 can cause the generator 330 to stop generating electrical power based on mechanical inputs from the user via the pedal 196. For example, the control device 190 cease transmission of an excitation current to the generator 330 to cause the generator 330 to stop generating electrical power. The control device 190 can operate the clutch 315 to disconnect the pedal assembly 195 from the first geartrain 320 to stop transmission of mechanical inputs from the user via the pedal 196 to the generator 330. In this way, operating the clutch 315 to disconnect the pedal assembly 195 from the first geartrain 320 can cause the generator 330 to stop generating electrical power.

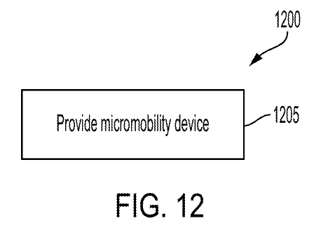

FIG. 12 is a flow diagram of a method 1200 of providing a micromobility device 100. Providing the micromobility device 100 (act 1205) can include assembling, manufacturing, shipping, building, offering, or otherwise providing the micromobility device 100 described herein.

In various embodiments, the micromobility device may be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A micromobility device, comprising:
a frame;
a first wheel and a second wheel rotatably coupled with the frame;
a battery coupled with the frame;
a drive unit coupled with the frame, the drive unit including:
a pedal assembly configured to receive mechanical input from a user;
a generator coupled with the pedal assembly and configured to generate electrical power to charge the battery based on the mechanical input applied by the user to the pedal assembly; and
a traction motor coupled with the second wheel, the traction motor configured to:
convert electrical power to mechanical power to drive the second wheel to propel the micromobility device, and
exert, based on a brake input, resistive torque on the second wheel to convert mechanical power from the second wheel to electrical power to cause the micromobility device to slow without use of friction brakes;
at least one resistor configured to receive electrical power from the traction motor and to convert the electrical power to heat; and
a control device configured to:
direct the electrical power generated by the traction motor to the battery based on the battery having a state of charge less than a threshold, and
direct the electrical power generated by the traction motor to the at least one resistor based on the battery having a state of charge greater than or equal to a threshold.

2. The micromobility device of claim 1, wherein the at least one resistor includes:
a first resistor positioned within the drive unit; and
a second resistor positioned within the frame and coupled with a stand extending between an inner surface of the frame and the second resistor, such that the second resistor is spaced apart from the inner surface of the frame,
wherein the control device is configured to direct a first portion of the electrical power generated by the traction motor to the first resistor and a second portion of the electrical power generated by the traction motor to the second resistor.

3. The micromobility device of claim 1, wherein the drive unit includes a housing, the housing including:
a front side adjacent to the first wheel; and
the housing defining at least one opening positioned on the front side, the at least one opening configured to allow air to flow into the housing,
wherein the at least one resistor is positioned between the battery and the front side of the housing, such that at least a portion of the heat generated by the at least one resistor is dissipated by the air flow through the at least one opening.

4. The micromobility device of claim 1, wherein the drive unit includes a housing, the housing including:
a front side adjacent to the first wheel; and
the housing defining at least one opening positioned on the front side, the at least one opening configured to allow air to flow into the housing,
wherein:
the at least one resistor is coupled with a component of the drive unit, such that the at least one resistor is positioned between the component of the drive unit and the front side of the housing, such that at least a portion of the heat generated by the at least one resistor is dissipated by the air flow through the at least one opening, and
a heat sink having a plurality of fins is coupled with a surface of the at least one resistor such that the plurality of fins extend away from the at least one resistor and towards the front side of the housing, the plurality of fins configured to dissipate at least a portion of the heat generated by the at least one resistor.

5. The micromobility device of claim 1, wherein the at least one resistor includes:
a first resistor having a first capacity, the first resistor positioned within the drive unit;
a second resistor having a second capacity, the second resistor positioned within the drive unit; and
a third resistor having a third capacity, the third resistor positioned within the frame and coupled with a stand extending between an inner surface of the frame and the third resistor, such that the third resistor is spaced apart from the inner surface of the frame,
wherein the control device is configured to:
detect an amount electrical power generated by the traction motor; and
direct the electrical power to the first resistor, based on the electrical power being less than or equal to the first capacity;
direct a first portion electrical power to the first resistor and a second portion of the electrical power to the second resistor, based on the electrical power being greater than the first capacity but less than the first capacity combined with the second capacity; and
direct a third portion electrical power to the first resistor, a fourth portion of the electrical power to the second resistor, and a fifth portion of the electrical power to the third resistor based on the electrical power being greater than the first capacity combined with the second capacity.

6. The micromobility device of claim 1, wherein the at least one resistor includes:
a first resistor positioned within the drive unit; and
a second resistor positioned within a down tube of the frame and coupled with a stand extending between an inner surface of the down tube and the second resistor, such that the second resistor is spaced apart from the inner surface of the down tube,
wherein the control device is configured to:
receive data indicative of a temperature of the drive unit and of a temperature of the down tube;
direct the electrical power to the first resistor based on the temperature of the drive unit being less than a first temperature threshold or based on the temperature of the down tube being greater than a second temperature threshold; and
direct the electrical power to the second resistor based on the temperature of the drive unit being greater than the first temperature threshold or based on the temperature of the down tube being less than the second temperature threshold.

7. The micromobility device of claim 1, wherein the at least one resistor is positioned within a down tube of the frame, the down tube extending away from the drive unit, and the at least one resistor includes:
at least one resistive device configured to receive the electrical power generated by the traction motor and to convert the electrical power to heat,
a heat sink coupled with the at least one resistive device, the heat sink configured to receive the heat generated by the at least one resistive device,
an insulating layer coupled with the heat sink, such that the heat sink is positioned between the insulating layer and the at least one resistive device, the insulating layer configured to limit heat transfer from the heat sink to a stand, and
the stand having a base and one or more legs extending away from the base, the base of the stand coupled with the insulating layer and the one or more legs coupled with an inner surface of the down tube.

8. The micromobility device of claim 1, wherein the at least one resistor is positioned within a down tube of the frame, the down tube extending away from the drive unit, and the at least one resistor includes:
a nichrome wire coil configured to receive the electrical power generated by the traction motor and to convert the electrical power to heat,
a heat sink coupled with the nichrome wire coil, the heat sink configured to receive the heat generated by the nichrome wire coil,
an insulating layer coupled with the heat sink, such that the heat sink is positioned between the insulating layer and the nichrome wire coil, the insulating layer configured to limit heat transfer from the heat sink to a stand, and
the stand having a base and one or more legs extending away from the base, the base of the stand coupled with the insulating layer and the one or more legs coupled with an inner surface of the down tube.

9. A brake system of a micromobility device, comprising:
a drive unit coupled with a frame of the micromobility device, the drive unit including:
a generator configured to generate electrical power to charge a battery based on a mechanical input applied by a user to a component of the micromobility device; and
a traction motor coupled with a wheel of the micromobility device, the traction motor configured to:
convert electrical power to mechanical power to drive the wheel, thereby propelling the micromobility device, and
exert, based on a brake input, resistive torque on the wheel, thereby converting mechanical power from the wheel to electrical power and causing the micromobility device to slow,
at least one resistor configured to receive electrical power from the traction motor and to convert the electrical power to heat, and
a control device configured to:
direct the electrical power generated by the traction motor to the battery based on the battery having a state of charge less than a threshold, and
direct the electrical power generated by the traction motor to the at least one resistor based on the battery having a state of charge greater than or equal to a threshold.

10. The brake system of claim 9, wherein the at least one resistor includes:
a first resistor positioned within the drive unit; and
a second resistor positioned within the frame and coupled with a stand extending between an inner surface of the frame and the second resistor, such that the second resistor is spaced apart from the inner surface of the frame,
wherein the control device is configured to direct a first portion of the electrical power generated by the traction motor to the first resistor and a second portion of the electrical power generated by the traction motor to the second resistor.

11. The brake system of claim 9, wherein the drive unit includes a housing, the housing including:
a front side; and
the housing defining at least one opening positioned on the front side, the at least one opening configured to allow air to flow into the housing,
wherein the at least one resistor is positioned between the battery and the front side of the housing, such that at least a portion of the heat generated by the at least one resistor is dissipated by the air flow through the at least one opening.

12. The brake system of claim 9, wherein the drive unit includes a housing, the housing including:
a front side; and
the housing defining at least one opening positioned on the front side, the at least one opening configured to allow air to flow into the housing,
wherein:
the at least one resistor is coupled with a component of the drive unit, such that the at least one resistor is positioned between the component of the drive unit and the front side of the housing, such that at least a portion of the heat generated by the at least one resistor is dissipated by the air flow through the at least one opening, and
a heat sink having a plurality of fins is coupled with a surface of the at least one resistor such that the plurality of fins extend away from the at least one resistor and towards the front side of the housing, the plurality of fins configured to dissipate at least a portion of the heat generated by the at least one resistor.

13. The brake system of claim 9, wherein the at least one resistor includes:
a first resistor having a first capacity, the first resistor positioned within the drive unit;
a second resistor having a second capacity, the second resistor positioned within the drive unit; and
a third resistor having a third capacity, the third resistor positioned within the frame and coupled with a stand extending between an inner surface of the frame and the third resistor, such that the third resistor is spaced apart from the inner surface of the frame,
wherein the control device is configured to:
detect an amount electrical power generated by the traction motor; and
direct the electrical power to the first resistor, based on the electrical power being less than or equal to the first capacity;
direct a first portion electrical power to the first resistor and a second portion of the electrical power to the second resistor, based on the electrical power being greater than the first capacity but less than the first capacity combined with the second capacity; and
direct a third portion electrical power to the first resistor, a fourth portion of the electrical power to the second resistor, and a fifth portion of the electrical power to the third resistor based on the electrical power being greater than the first capacity combined with the second capacity.

14. The brake system of claim 9, wherein the at least one resistor includes:
a first resistor positioned within the drive unit; and
a second resistor positioned within a down tube of the frame and coupled with a stand extending between an inner surface of the down tube and the second resistor, such that the second resistor is spaced apart from the inner surface of the down tube,
wherein the control device is configured to:
receive data indicative of a temperature of the drive unit and of a temperature of the down tube;
direct the electrical power to the first resistor based on the temperature of the drive unit being less than a first temperature threshold or based on the temperature of the down tube being greater than a second temperature threshold; and
direct the electrical power to the second resistor based on the temperature of the drive unit being greater than the first temperature threshold or based on the temperature of the down tube being less than the second temperature threshold.

15. The brake system of claim 9, wherein the at least one resistor is positioned within a down tube of the frame, the down tube extending away from the drive unit, and the at least one resistor includes:
at least one resistive device configured to receive the electrical power generated by the traction motor and to convert the electrical power to heat,
a heat sink coupled with the at least one resistive device, the heat sink configured to receive the heat generated by the at least one resistive device,
an insulating layer coupled with the heat sink, such that the heat sink is positioned between the insulating layer and the at least one resistive device, the insulating layer configured to limit heat transfer from the heat sink to a stand, and
the stand having a base and one or more legs extending away from the base, the base of the stand coupled with the insulating layer and the legs coupled with an inner surface of the down tube.

16. The brake system of claim 9, wherein the at least one resistor is positioned within a down tube of the frame, the down tube extending away from the drive unit, and the at least one resistor includes:
a nichrome wire coil configured to receive the electrical power generated by the traction motor and to convert the electrical power to heat,
a heat sink coupled with the nichrome wire coil, the heat sink configured to receive the heat generated by the nichrome wire coil,
an insulating layer coupled with the heat sink, such that the heat sink is positioned between the insulating layer and the nichrome wire coil, the insulating layer configured to limit heat transfer from the heat sink to a stand, and
the stand having a base and one or more legs extending away from the base, the base of the stand coupled with the insulating layer and the legs coupled with an inner surface of the down tube.

17. A method, comprising:
providing a frame of a micromobility device;
rotatably coupling a first wheel and a second wheel with the frame;
coupling a drive unit with the frame, the drive unit including a battery, a pedal assembly configured to receive mechanical input from a user, a generator, and a traction motor;
coupling the generator with the pedal assembly, the generator configured to generate electrical power to charge the battery based on the mechanical input applied by the user to the pedal assembly;
coupling the traction motor with the second wheel, the traction motor configured to:
convert electrical power to mechanical power to drive the second wheel, thereby propelling the micromobility device, and
exert, based on a brake input, resistive torque on the second wheel, thereby converting mechanical power from the second wheel to electrical power and causing the micromobility device to slow without use of friction brakes,
providing at least one resistor configured to receive electrical power from the traction motor and to convert the electrical power to heat;
directing, by a control device, the electrical power generated by the traction motor to the battery based on the battery having a state of charge less than a threshold; and
directing, by a control device, the electrical power generated by the traction motor to the at least one resistor based on the battery having a state of charge greater than or equal to a threshold.

18. The method of claim 17, comprising:
positioning a first resistor within the drive unit;
positioning a second resistor within the frame, the second resistor coupled with a stand extending between an inner surface of the frame and the second resistor, such that the second resistor is spaced apart from the inner surface of the frame;
directing, by the control device, a first portion of the electrical power generated by the traction motor to the first resistor; and
directing, by the control device, a second portion of the electrical power generated by the traction motor to the second resistor.

19. The method of claim 17, comprising:
positioning a first resistor having a first capacity within the drive unit;
positioning a second resistor having a second capacity within the drive unit;
positioning a third resistor having a third capacity within the frame, the third resistor coupled with a stand extending between an inner surface of the frame and the third resistor, such that the third resistor is spaced apart from the inner surface of the frame;
detecting, by the control device, an amount electrical power generated by the traction motor;
directing, by the control device, the electrical power to the first resistor, based on the electrical power being less than or equal to the first capacity;
directing, by the control device, a first portion electrical power to the first resistor and a second portion of the electrical power to the second resistor, based on the electrical power being greater than the first capacity but less than the first capacity combined with the second capacity; and
directing, by the control device, a third portion electrical power to the first resistor, a fourth portion of the electrical power to the second resistor, and a fifth portion of the electrical power to the third resistor based on the electrical power being greater than the first capacity combined with the second capacity.

20. The method of claim 17, comprising:
positioning a first resistor within the drive unit;
positioning a second resistor within a down tube of the frame, the second resistor coupled with a stand extending between an inner surface of the down tube and the second resistor, such that the second resistor is spaced apart from the inner surface of the down tube;
receiving, by the control device, data indicative of a temperature of the drive unit and of a temperature of the down tube;
directing, by the control device, the electrical power to the first resistor based on the temperature of the drive unit being less than a first temperature threshold or based on the temperature of the down tube being greater than a second temperature threshold; and
directing, by the control device, the electrical power to the second resistor based on the temperature of the drive unit being greater than the first temperature threshold or based on the temperature of the down tube being less than the second temperature threshold.
